(19) United States
(12) Patent Application Publication
(10) Pub. No.: US 2026/0077920 A1
(43) Pub. Date: Mar. 19, 2026

(54) CARRIER FOR CONTAINERS

(71) Applicant: Graphic Packaging International, LLC, Atlanta, GA (US)

(72) Inventor: Meng-Chuan Wu, Norcross, GA (US)

(21) Appl. No.: 19/330,529

(22) Filed: Sep. 16, 2025

Related U.S. Application Data
(60) Provisional application No. 63/695,584, filed on Sep. 17, 2024.

(51) Int. Cl. B65D 71/42; B31B 50/20

(52) U.S. Cl. CPC B65D 71/42; B31B 50/20; B31B 2241/001

(57) ABSTRACT

A carrier for holding a plurality of containers is disclosed. The carrier includes a main panel with a finger opening defined along a perimeter and a finger flap foldably connected to the main panel at a fold line extending along a portion of the perimeter. At least one relief cut is formed through the main panel outside the perimeter and adjacent to the fold line. The relief cut may be arcuate, and multiple relief cuts may be provided, spaced apart by gaps and arranged at different distances from the perimeter. The carrier may be formed from a blank including these features. A method for forming the carrier from the blank is also provided.

### CROSS-REFERENCES TO OTHER APPLICATIONS

This application claims priority to U.S. provisional patent application Ser. No. 63/695,584 for “CARRIER FOR CONTAINERS” filed on Sep. 17, 2024, which is hereby incorporated by reference in entirety for all purposes.

### TECHNICAL FIELD

This disclosure pertains to blanks for forming carriers, carriers, and methods for forming the carriers from the blanks. More specifically, the present disclosure pertains to carriers with finger holes cut lines for controlling or redirecting tears that may form in the carriers.

### BACKGROUND OF THE DISCLOSURE

Carriers are commonly used to group and transport multiple containers, such as bottles or cans, in a single package. Conventional carriers often include a main panel with openings or flaps that allow users to grasp and carry the package. During handling, stress is frequently concentrated around these grasping regions, particularly at finger holes or cutouts. This concentration of stress can result in tearing or failure of the main panel, which may cause containers to become dislodged or the package to lose integrity. In some cases, tear propagation may compromise the retention features designed to securely hold containers. New carriers are needed that have improved tear resistance.

### SUMMARY OF THE DISCLOSURE

A carrier for holding a plurality of containers may comprise a main panel. The carrier may comprise a receptacle defined in the main panel for holding a container. The carrier may comprise a finger opening defined within the main panel along a perimeter. The carrier may comprise a finger flap defined in the main panel and foldably connected to the main panel at a fold line extending along a portion of the perimeter. The carrier may comprise a relief cut formed in the main panel, where the relief cut may be positioned outside the perimeter and adjacent to the fold line. The perimeter may be substantially circular. The relief cut may be arcuate. The relief cut may be a first relief cut, and the carrier may include a second relief cut formed through the main panel and separated from the first relief cut by a gap. The first and the second relief cuts may be spaced away from the perimeter by a first distance and the carrier may include a third relief cut formed through the main panel and aligned with the gap, where the third relief cut may be spaced away from the perimeter by a second distance that may be greater than the first distance. Each of the first and second relief cuts may be arcuate, and each of the first and second relief cuts may have a first radius and the third relief cut may be arcuate and may have a second radius that may be larger than the first radius. Each of the first and second relief cuts may be arcuate, and each of the first and second relief cuts may have a same radius. The relief cut may be a first relief cut, and the carrier may further comprise a second relief cut arcuate in shape, formed through the main panel and aligned with a first end of the first relief cut. The carrier may further comprise a third relief cut semicircular in shape, formed through the main panel and aligned with a second end of the first relief cut. The first relief cut may include a first portion separated from a second portion by a gap. The perimeter of the finger opening may be an elongated circle.

A blank for forming a carrier for holding a plurality of containers may comprise a main panel. The blank may comprise a receptacle defined in the main panel for holding a container. The blank may comprise a finger opening defined within the main panel along a perimeter. The blank may comprise a finger flap defined in the main panel and foldably connected to the main panel at a fold line extending along a portion of the perimeter. The blank may comprise a relief cut formed in the main panel, where the relief cut may be positioned outside the perimeter and adjacent to the fold line. The perimeter may be substantially circular. The relief cut may be arcuate. The relief cut may be a first relief cut, and the blank may include a second relief cut formed through the main panel and separated from the first relief cut by a gap. The first and the second relief cuts may be spaced away from the perimeter by a first distance and the blank may include a third relief cut formed through the main panel and aligned with the gap, where the third relief cut may be spaced away from the perimeter by a second distance that may be greater than the first distance. Each of the first and second relief cuts may be arcuate, and each of the first and second relief cuts may have a first radius and the third relief cut may be arcuate and may have a second radius that may be larger than the first radius. Each of the first and second relief cuts may be arcuate, and each of the first and second relief cuts may have a same radius. The relief cut may be a first relief cut, and the blank may further comprise a second relief cut formed through the main panel and arranged in an arcuate shape that may be aligned with a first end of the first relief cut. The relief cut may be a first relief cut, and the carrier may further comprise a second relief cut semicircular in shape, formed through the main panel and aligned with a first end of the first relief cut. The carrier may further comprise a third relief cut semicircular in shape, formed through the main panel and aligned with a second end of the first relief cut. The first relief cut may include a first portion separated from a second portion by a gap. The perimeter of the finger opening may be an elongated circle.

A method for forming, from a blank, a carrier for holding a plurality of containers may comprise receiving a blank that may include a main panel. The blank may include a receptacle defined in the main panel for holding a container. The blank may include a finger opening defined within the main panel along a perimeter. The blank may include a finger flap defined in the main panel and foldably connected to the main panel at a fold line extending along a portion of the perimeter. The blank may include a relief cut formed in the main panel, where the relief cut may be positioned outside the perimeter and adjacent to the fold line. The method may comprise forming the carrier from the blank. The perimeter may be substantially circular. The relief cut may be arcuate. The relief cut may be a first relief cut, and the carrier may include a second relief cut formed through the main panel and separated from the first relief cut by a gap. The first and the second relief cuts may be spaced away from the perimeter by a first distance and the carrier may include a third relief cut formed through the main panel and aligned with the gap, where the third relief cut may be spaced away from the perimeter by a second distance that may be greater than the first distance. Each of the first and second relief cuts may be arcuate, and each of the first and second relief cuts may have a first radius and the third relief cut may be arcuate and may have a second radius that may be larger than the first radius. Each of the first and second relief cuts may be arcuate, and each of the first and second relief cuts may have a same radius. The relief cut may be a first relief cut, and the carrier may further comprise a second relief cut arcuate in shape, formed through the main panel and aligned with a first end of the first relief cut. The carrier may further comprise a third relief cut semicircular in shape, formed through the main panel and aligned with a second end of the first relief cut. The first relief cut may include a first portion separated from a second portion by a gap. The perimeter of the finger opening may be an elongated circle.

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a construct or carrier for holding a plurality of articles according to embodiments of the disclosure.

FIGS. 2A-2D are multiple views of a package formed by the carrier holding a plurality of articles according to embodiments of the disclosure.

FIG. 3 is a plan view of a blank including a plurality of carriers that are separable from one another along lines of weakening according to embodiments of the disclosure.

FIG. 4 is a plan view of a carrier for engaging containers to form a package of a second embodiment of the disclosure.

FIG. 5 is a plan view of a blank including a plurality of carriers for forming packages of the second embodiment of the disclosure.

FIG. 6 is a plan view of a carrier for engaging containers to form a package of a third embodiment of the disclosure.

FIG. 7 is a plan view of a blank including a plurality of carriers for forming packages of the third embodiment of the disclosure.

FIGS. 8A-8C are detail plan views of grasping features of embodiments of the disclosure.

FIGS. 9A-9B are plan views of carriers of additional embodiments with different grasping features of the disclosure.

Corresponding parts are designated by corresponding reference numbers throughout the drawings.

### DETAILED DESCRIPTION OF THE EXEMPLARY EMBODIMENTS

The present disclosure generally relates to various features for cartons, sleeves, wraps, and/or carriers that contain or retain articles such as containers, bottles, jars, cans, etc. The articles can be used for packaging beverage and/or food products, for example. The articles can be made from materials suitable in composition for packaging the particular beverage or food item, and the materials include, but are not limited to, plastics such as PET, LDPE, LLDPE, HDPE, PP, PS, PVC, EVOH, and Nylon; glass; aluminum and/or other metals; and the like, or any combination thereof.

Cartons or carriers according to the present disclosure can accommodate articles of any suitable shape. For the purpose of illustration and not for the purpose of limiting the scope of the disclosure, the following detailed description describes beverage and/or food containers (e.g., plastic bottles, such as for beverages, including water, sports drinks, sodas, juices, etc., and/or other suitable beverages and/or foods; glass and/or other bottles; beverage cans; food cans; etc.) as disposed within the carrier embodiments. In this specification, the terms “inner,” “interior,” “outer,” “exterior,” “lower,” “bottom,” “upper,” and “top” indicate orientations determined in relation to fully erected and upright cartons. As described herein, constructs can be formed with multiple walls, panels, portions, tabs, flaps, fold lines, and/or other aspects, which may be designated herein in terms relative to one another, e.g., “first,” “second,” “third,” etc., in sequential or nonsequential reference, without departing from the disclosure.

The disclosed technology may address challenges associated with tear resistance in container carriers by incorporating relief cuts that may control tear propagation around finger openings. A carrier may be formed from a blank and may include a main panel that serves as the primary structural component for holding multiple containers. The main panel may define a finger opening that allows users to grasp and transport the carrier. A finger flap may be foldably connected to the main panel at a fold line, where the fold line may extend along a portion of the perimeter of the finger opening. The finger flap may provide additional structural support and may facilitate user handling of the carrier.

The relief cut may be strategically positioned outside the perimeter of the finger opening and adjacent to the fold line. This positioning may help redirect stress forces that typically concentrate around the finger opening during handling and transportation. The relief cut may function as a controlled failure point that may prevent uncontrolled tearing from propagating through other areas of the main panel. When stress may be applied to the carrier, the relief cut may redirect and distribute the forces, thereby maintaining the structural integrity of the container retention features and the overall carrier assembly.

The relief cut configuration may be implemented in various geometric arrangements to optimize tear control performance. The relief cut may be arcuate in shape, which may provide smooth stress distribution along its length. Multiple relief cuts may be employed, where a first relief cut and a second relief cut may be separated by a gap to create a distributed stress relief system. Additional relief cuts may be positioned at varying distances from the finger opening perimeter to create a multi-tiered stress management system. The relief cuts may have different radii and may be arranged in patterns that may complement the expected stress distribution patterns during typical carrier usage scenarios. The relief cut may be formed through an entire thickness of the carrier or through only a portion of the thickness.

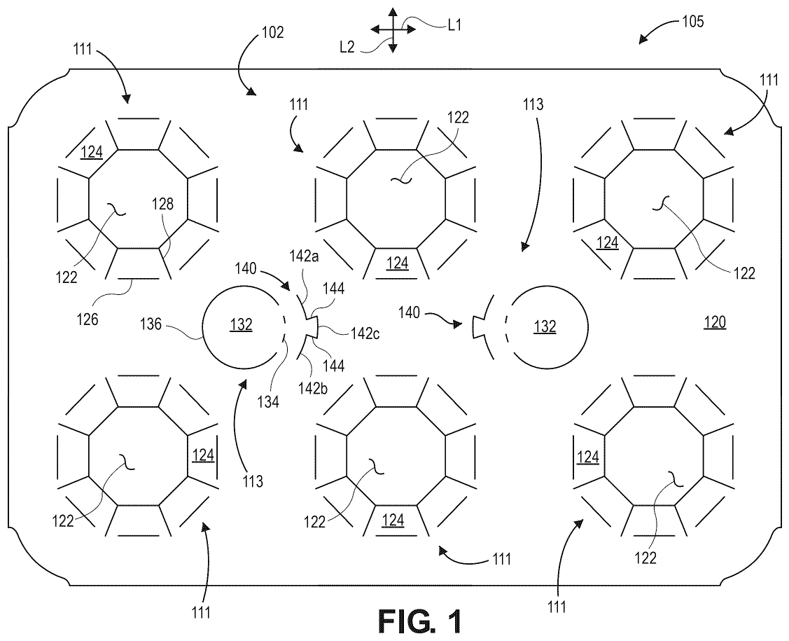

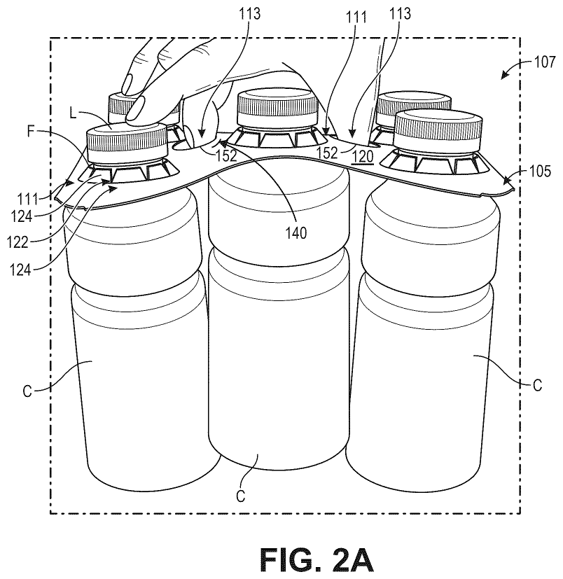

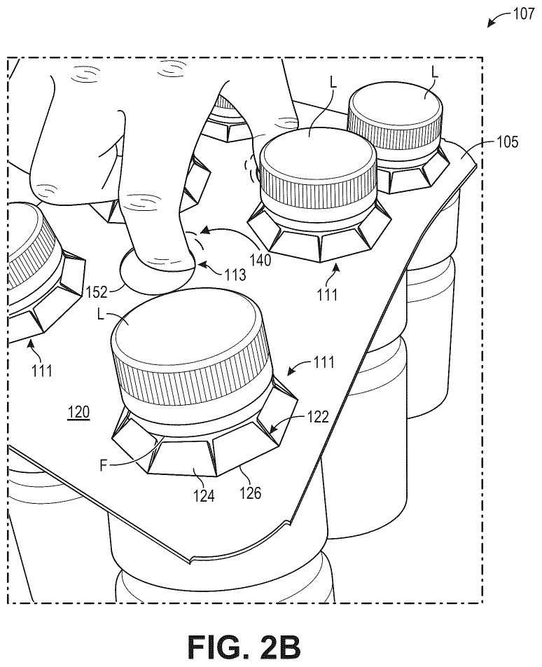

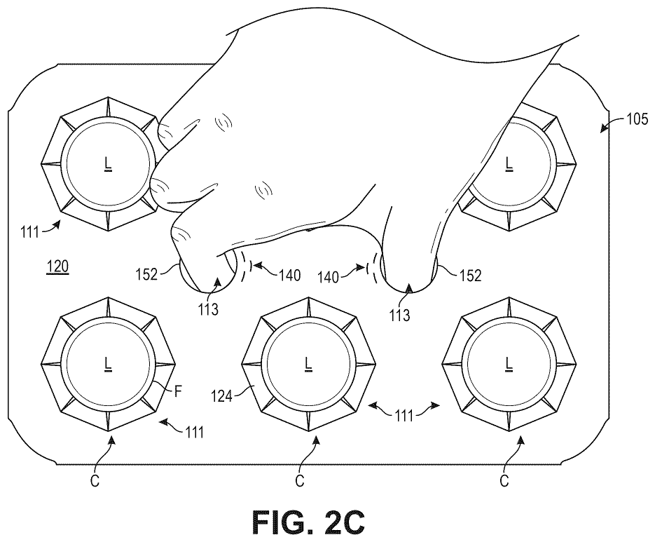

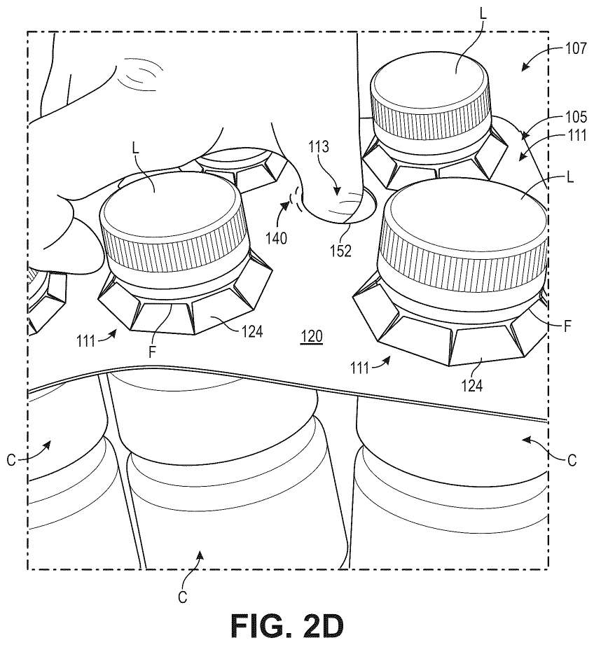

FIG. 1 is a plan view of an exterior surface 102 of a construct or carrier 105 for holding a plurality of articles, such as containers C (not shown in FIG. 1), to form a package 107 (shown in FIGS. 2A-2D), according to embodiments of the disclosure. In the illustrated embodiments, the containers C are beverage bottles or other suitable containers (e.g., beverage cans, food containers, etc.), each having a top portion or lid L and a rim or flange F. The carrier 105 can be sized to house six containers C in a single layer in a 2×3 arrangement, but it is understood that the carrier 105 may be sized and shaped to hold containers of a different or same quantity in more than one layer and/or in different row/column arrangements e.g., 1×6, 2×6, 3×2, 3×4, 4×6, 3×8, 2×6×2, 3×4×2, 2×9, 3×6, etc.), or just a single article. In the illustrated embodiments, the containers C can be at least partially retained in a respective container-receiving feature or receptacle 111 at least partially defined in two rows in the carrier 105. As shown in FIG. 1, the carrier 105 can include grasping/carrying features 113 (e.g., FIG. 1 has two grasping features 113) for grasping and/or carrying the package 107.

As shown in FIG. 1, the carrier 105 has a longitudinal axis L1 and a lateral axis L2. In the illustrated embodiments, the carrier 105 can include a main or top panel 120 with the receptacles 111 defined within the main panel 120. In some embodiments, each of the receptacles 111 can include an aperture 122 and a plurality of locking tabs 124 foldably connected to the main panel 120 along the aperture 122. In some embodiments, each of the locking tabs 124 can be foldably connected to the main panel 120 along a respective fold line 126 (e.g., a longitudinal fold line, lateral fold line, or oblique fold line, depending on the location of the respective locking tab 124 around the receptacle 111). In some embodiments, the locking tabs 124 can be separable from respectively adjacent locking tabs 124 along cut lines 128 (e.g., oblique cut lines). Alternatively, the locking tabs 124 could be separable from one another along other suitable lines of weakening and/or could be spaced apart from one another. In the illustrated embodiments, each of the receptacles 111 includes eight locking tabs 124 arranged along the respective apertures 122. Alternatively, the receptacles 111 could include any suitable number of locking tabs 124. Any of the receptacles 111 could be omitted or could be otherwise shaped, arranged, positioned, and/or configured without departing from the disclosure.

In the illustrated embodiments, the grasping features 113 can each include a finger flap 132 foldably connected to the main panel 120 along a curved fold line 134 or other suitable line of weakening). As shown in FIG. 1, the finger flap 132 can be separable from the main panel 120 along a tear or cut line 136. In some embodiments, the curved fold line 134 and the cut line 136 can define a perimeter of a finger opening 152 (not shown in FIG. 1, see, for example, FIGS. 2A-2D) formed by folding the finger flap 132 and at least partially form a circle or other suitable shape. The finger flaps 132 could be otherwise shaped, arranged, positioned, and/or configured without departing from the disclosure.

As shown in FIG. 1, each of the grasping features 113 can include a relief feature 140 spaced inwardly from and adjacent to the respective finger flap 132, outside of the perimeter formed by fold line 134 and cut line 136. In some embodiments, each of the relief features 140 can include first, second and third relief cuts 142a, 142b, 142c, respectively, that may be arcuate in shape. In some embodiments, the first, second and third relief cuts 142a, 142b, 142c, respectively, can be concentric, for example, and the first and second cuts 142a, 142b, respectively, can be spaced apart segments of the same circle or ellipse, for example. Thus, first and second relief cuts 142a, 142b, respectively, can have the same radius of curvature and can be spaced apart by a gap. The first and second relief cuts 142a, 142b, respectively, can be offset from the perimeter of the finger flap 132 by any suitable distance. Third relief cut 142c can be aligned with the gap and may have a different radius of curvature. The third relief cut 142c can be offset from the perimeter of the finger flap by a distance that is greater than the offset distance associated with first and second relief cuts 142a, 142b, respectively. In the illustrated embodiments, each of the ends of the third relief cut 142c can be connected to respective ends of each of the first and second relief cuts 142a, 142b, respectively, along respective optional creases 144 (e.g., oblique creases or other suitable lines of weakening). The relief features 140 may be otherwise shaped, arranged, positioned, and/or configured without departing from the disclosure. For example, one or both of the creases 144 could be omitted. For example, the relief cuts could be straight cuts, serpentine, concave curved and/or convex curved cuts, a single arcuate cut or multiple concentric cuts that are offset from one another (e.g., radially and/or circumferentially).

In some embodiments each of the first, second and third relief cuts, 142a, 142b, 142c, respectively, can be formed through an entire thickness of the carrier, however in other embodiments each of the relief cuts may be formed through only a portion of the thickness of the carrier (e.g., through 25 percent or less, through 50 percent or less, through 75 percent or less of the thickness). In further embodiments ach of the first, second and third relief cuts, 142a, 142b, 142c, respectively, may be formed differently, (e.g., the first and second relief cuts 142a, 142b, respectively, may be formed through 50 percent of the thickness and the third relief cut 142c may be formed through 100 percent of the thickness.

The carrier 105 could be otherwise shaped, arranged, and/or configured without departing from the disclosure. For example, any suitable number of grasping features 113 could be included. In other examples, the carrier 105 could include multiple layers that can be glued together and/or can be foldably connected. In further examples, the carrier 105 could include additional panels and/or flaps, such as side panels and end flaps.

In embodiments, the carrier 105 can be engaged with the containers C to form the package 107 as shown in FIGS. 2A-2D. For example, each of the containers C can be inserted into the respective receptacles 111 from the bottom of the carrier 105 so that the lid L and the flange F push upwardly through the respective aperture 122, pushing the locking tabs 124 upwardly relative to the main panel 120, folding along the respective fold lines 126. As shown in FIGS. 2A-2D, the locking tabs 124 can engage under the flanges F of the containers C (e.g., at respective distal edges of the locking tabs 124). The package 107 could be otherwise formed without departing from the disclosure.

As shown in FIGS. 2A-2D, the grasping features 113 (e.g., forming a handle in the carrier 105) can be engaged to grasp, hold, carry, etc. the package 107. For example, a user can insert a finger/thumb by pushing downwardly on the finger flaps 132 to separate the finger flaps 132 from the main panel 120 along the respective cut lines 136, folding along the respective curved fold lines 134. In embodiments, the downwardly folded finger flaps 132 can at least partially form respective finger openings 152 in the main panel that the user's fingers can extend into. As shown in the illustrated embodiments, the fingers can grasp the main panel 120 at the finger holes 152 to lift, hold, carry, etc. the package 107. In some embodiments, the relief features 140 can help avoid or reduce tearing of the main panel 120 due to stress from carrying the package 107 at the finger openings 152. For example, the relief features 140 can result in improved carrier pack strength based on drop-jolt testing of the package 107 compared to a carrier without the relief features.

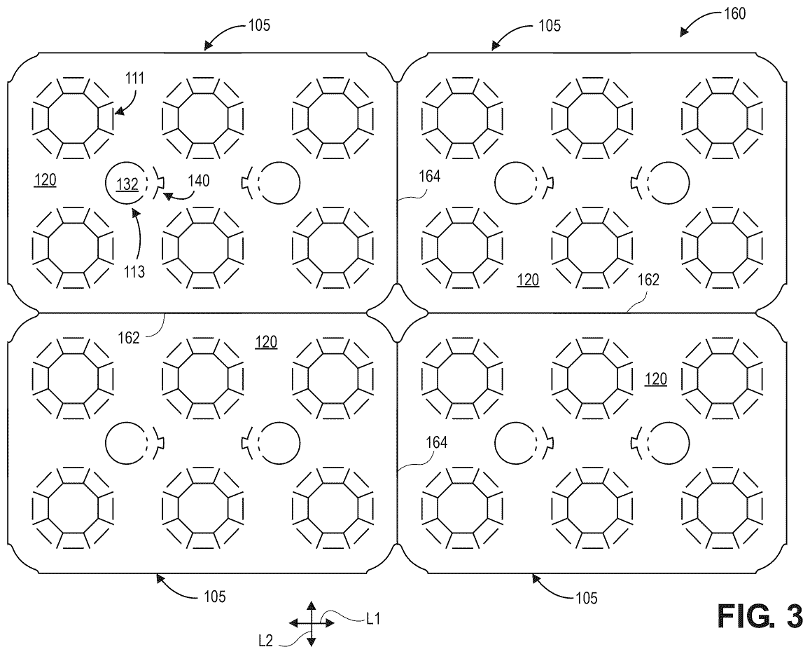

As shown in FIG. 3, the carriers 105 can be formed in a blank 160 including a plurality of carriers 105 (e.g., four or any suitable number of carriers 105, including a single carrier 105) that are separable from one another along longitudinal tear lines 162 and lateral tear lines 164 or other suitable lines of weakening (e.g., cut lines with spaced nicks). The blank 160 can be delivered to a package assembly system where the individual carriers 105 can be separated from one another before, during, and/or after engagement with respective sets of the containers C to form the packages 107. The blank 160 could be otherwise shaped, arranged, and/or configured without departing from the disclosure.

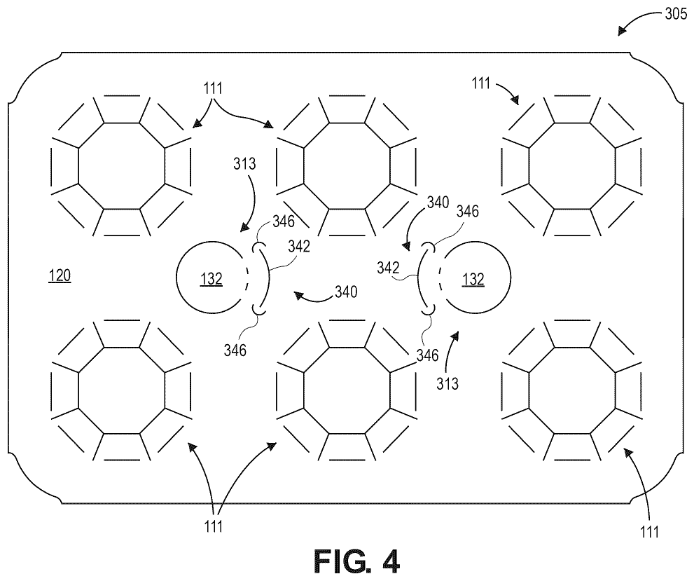

FIG. 4 is a plan view of a carrier 305 for engaging containers C to form a package (not shown) of a second embodiment of the disclosure. The second embodiment is generally similar to the first embodiment, except for variations noted and variations that will be apparent to one of ordinary skill in the art. Accordingly, similar or identical features of the embodiments have been given like or similar reference numbers. As shown in FIG. 4 the carrier 305 includes grasping features 313 with alternative relief features 340. In some embodiments, each of the relief features 340 can include an arcuate cut 342 radially spaced inwardly from, and adjacent to the respective finger flaps 132. As shown in FIG. 4, a curved relief cut or tear stop 346 spaced from each end of the arcuate cut 342 in each of the relief features 340. For example, the tear stops 346 can be semicircles or other suitable shapes that are centered on or aligned with the respective ends of the arcuate cut 342. Any of the arcuate cuts 342 and/or the tear stops 346 could be omitted or could be otherwise shaped, arranged, positioned, and/or configured without departing from the disclosure.

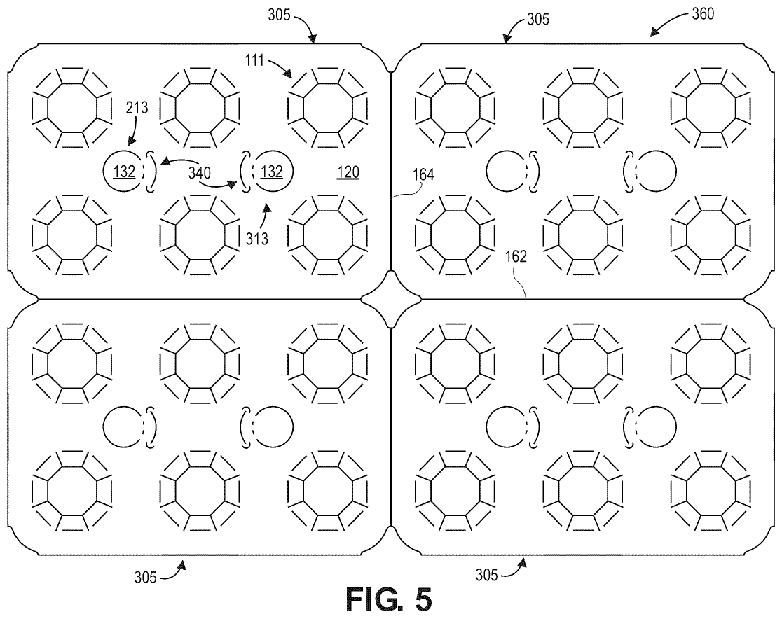

An example blank 360 including a plurality of carriers 305 is shown in FIG. 5. The carrier 305 and/or the blank 360 could be otherwise shaped, arranged, positioned, and/or configured without departing from the disclosure. The plurality of carriers 305 in the blank 360 could include four or any suitable number of carriers 305 including a single carrier 305 that may be separable from one another along longitudinal tear lines 162 and lateral tear lines 164 or other suitable lines of weakening (e.g., cut lines with spaced nicks).

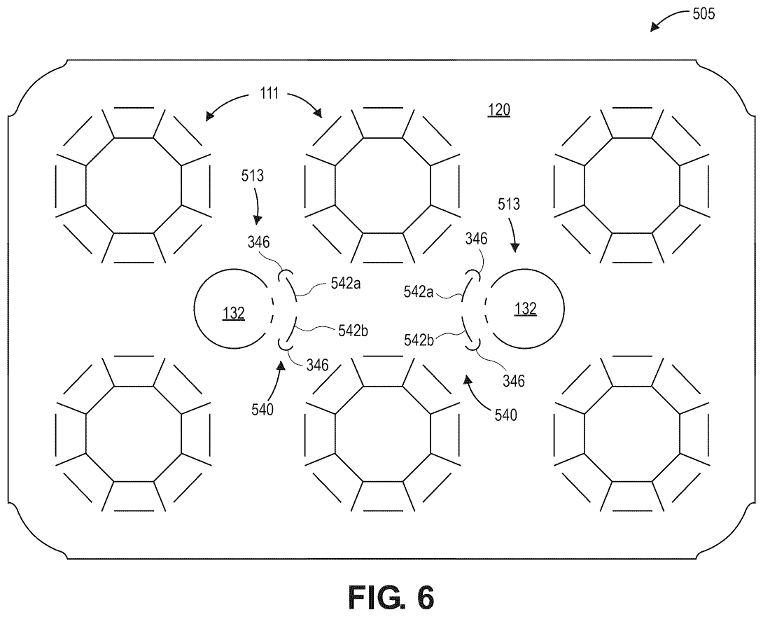

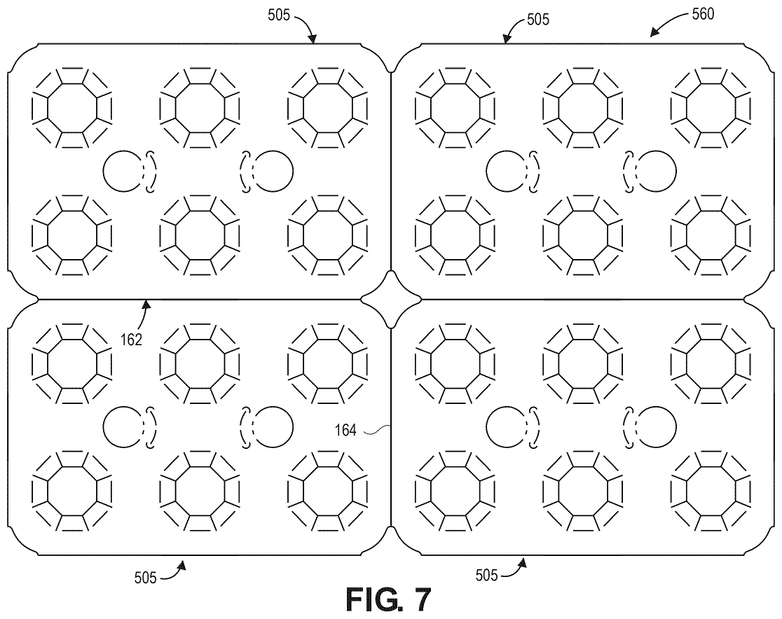

FIG. 6 is a plan view of a carrier 505 for engaging containers C to form a package (not shown) of a third embodiment of the disclosure. The third embodiment is generally similar to the prior embodiments, except for variations noted and variations that will be apparent to one of ordinary skill in the art. Accordingly, similar or identical features of the embodiments have been given like or similar reference numbers. As shown in FIG. 5 the relief features 540 of the grasping features 513 are similar to the relief features 340 of the prior embodiment, except that the arcuate cut 342 is replaced by two spaced arcuate cuts 542a, 542b. An example blank 560 including a plurality of carriers 505 is shown in FIG. 7. The carrier 505 and/or the blank 560 could be otherwise shaped, arranged, positioned, and/or configured without departing from the disclosure. The plurality of carriers 505 in the blank 560 could include four or any suitable number of carriers 505 including a single carrier 505.

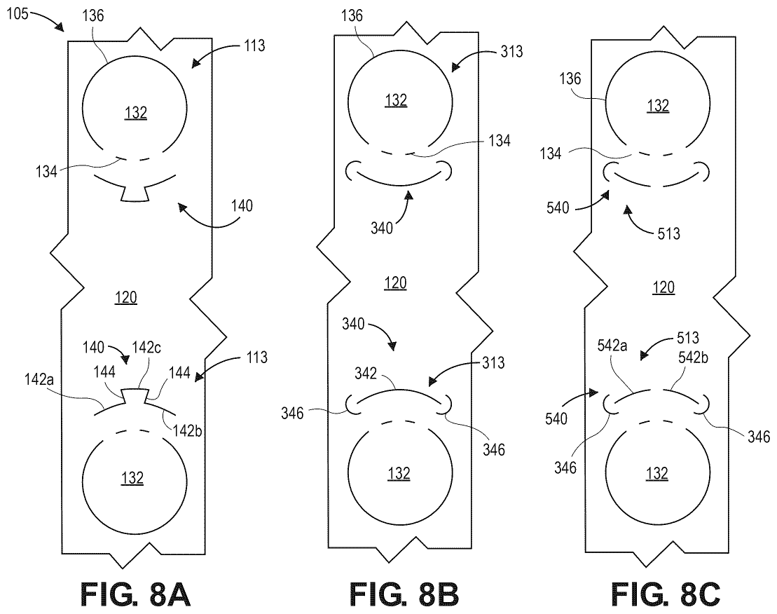

FIGS. 8A-8C are detail plan views of the grasping features 113, 313 and 513, respectively. FIG. 8A shows two grasping features 113 and the two relief features 140 associated with carrier 105 of FIG. 1. Each grasping feature 113 includes fold line 134 and cut line 136 that combine to form the perimeter of finger flap 132. The perimeter can be circular, rectangular, irregularly shaped, etc. The relief features 140 lie outside the perimeter and can be adjacent to and aligned with fold line 134. Each relief feature 140 can include first and second relief cuts 142a, 142b, respectively, that form arcuate curve lines with the same or similar radius of curvature separated by a gap. The relief feature 140 can also include a third relief cut 142c that is also arcuate, or other suitable shape e.g., straight) and aligned with the gap between the first and second relief cuts 142a, 142b, respectively. The third relief cut 142c can have a larger radius of curvature than the radius of curvature associated with first and second relief cuts 142a, 142b, respectively. The third relief cut 142c can be connected to the first and second relief cuts 142a, 142b, respectively, by the optional creases 144. Any of the first, second and third relief cuts 142a, 142b, 142c, respectively, can be concentric with the circular finger flap 132 or with each other.

The grasping features 313 of FIG. 8B may be similar to the grasping features 113 shown in FIG. 8A. Each relief feature 340 can include three relief cuts. The first relief cut 342 is outside the perimeter of the finger flap 132 and adjacent to fold line 134. The other two relief cuts 346 can form semicircles that are centered on endpoints of the first relief cut 342. The relief features 540 shown in FIG. 8C can be similar to the relief features 340 of FIG. 8B, but the first relief cut can be split into two separate relief cuts 542a, 542b. The two separate relief cuts 542a, 542b may be concentric with the circular finger flap 132.

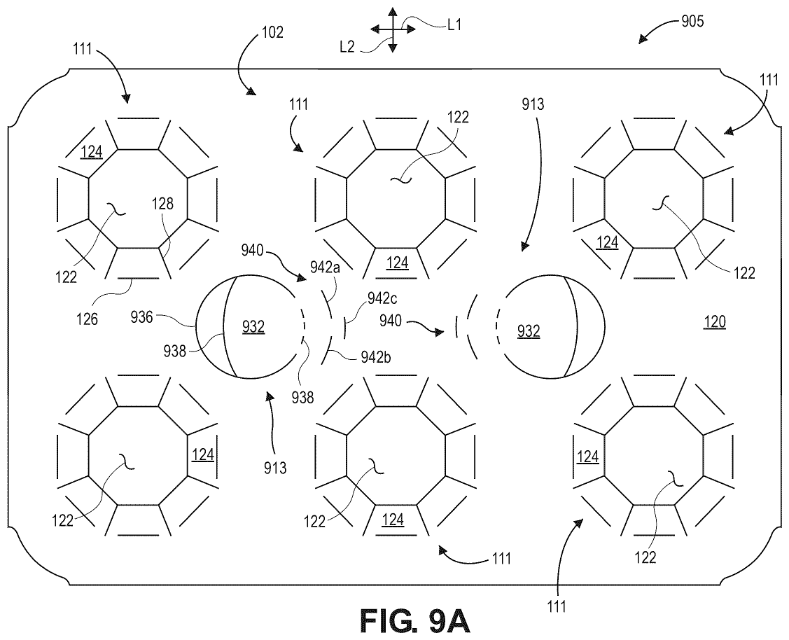

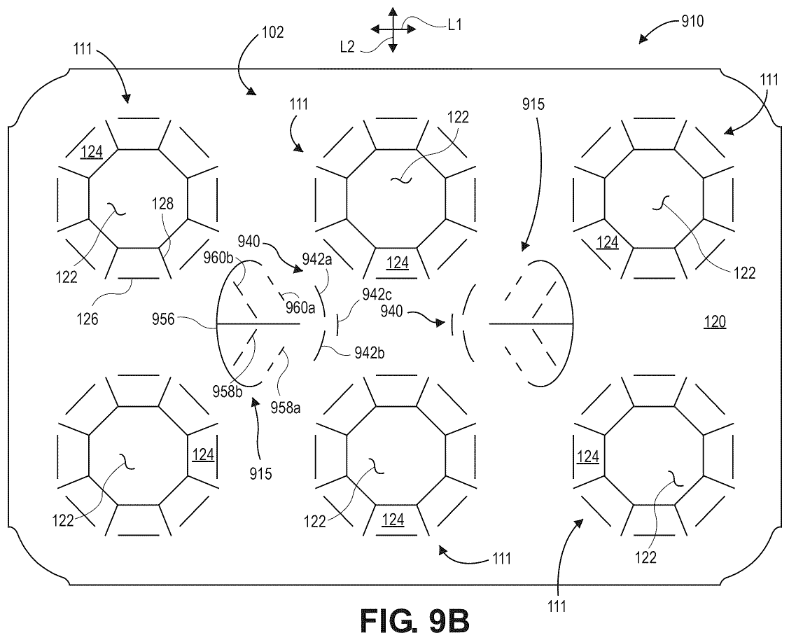

FIG. 9A illustrates a plan view of a grasping feature of a carrier 905 including relief features configured to control tear propagation in the main panel. As shown in FIG. 9A, carrier 905 includes a main panel with a grasping feature 913. Grasping feature 913 comprises a finger flap 932 defined by a cut line 936 and a fold line 934, which together form a substantially circular perimeter for the grasping feature. An additional cut line 938 forms a gibbous shape for the finger flap 932. Adjacent to the finger flap 932, relief feature 940 is provided. Relief feature 940 includes two arcuate relief cuts 942a and 942b, spaced apart from one another, and a third arcuate relief cut 942c aligned with the gap between relief cuts 942a and 942b. The relief cuts 942a, 942b, and 942c are configured to redirect or limit the propagation of tears that may originate near the grasping feature 913 during use.

FIG. 9B illustrates a plan view of a grasping feature of a carrier 910, wherein the grasping feature includes multiple fold lines and a relief feature configured to control tearing in the main panel. As shown in FIG. 9B, carrier 910 includes a main panel with a grasping feature 915. Grasping feature 915 is defined by a cut line 956, which has a straight-line portion and a curved-line portion. A first pair of fold lines 958a and 958b extend obliquely from the ends of the curved-line portion of cut line 956. A second pair of fold lines 960a and 960b extend obliquely from the straight-line portion of cut line 956. The combination of the curved line portion of cut line 956, the first pair of fold lines 958, and one end of the straight-line portion of cut line 956 forms an irregular, elongated circle or leaf-shaped perimeter for the grasping feature 915. Adjacent to the grasping feature 915, relief feature 940 is provided. Relief feature 940 includes two arcuate relief cuts 942a and 942b, spaced apart from one another, and a third arcuate relief cut 942c, which is aligned with the gap between relief cuts 942a and 942b. The relief cuts 942a, 942b, and 942c are arranged to redirect or limit the propagation of tears that may originate near the grasping feature 915 during handling of the carrier 910.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

Any of the features of the various embodiments of the disclosure can be combined with, replaced by, or otherwise configured with other features of other embodiments of the disclosure without departing from the scope of this disclosure.

In general, the blanks according to the present disclosure can be constructed from paperboard having a caliper so that it is heavier and more rigid than ordinary paper. The blanks can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding a plurality of containers, the carrier comprising:
a main panel;
a receptacle defined in the main panel for holding a container;
a finger opening defined within the main panel along a perimeter;
a finger flap defined in the main panel and foldably connected to the main panel at a fold line extending along a portion of the perimeter; and
a relief cut formed in the main panel, the relief cut positioned outside the perimeter and adjacent to the fold line.

2. The carrier of claim 1, wherein the perimeter is substantially circular.

3. The carrier of claim 1, wherein the relief cut is arcuate.

4. The carrier of claim 1, wherein the relief cut is a first relief cut, the carrier including a second relief cut formed through the main panel and separated from the first relief cut by a gap.

5. The carrier of claim 4, wherein the first and the second relief cuts are spaced away from the perimeter by a first distance and wherein the carrier includes a third relief cut formed through the main panel and aligned with the gap, the third relief cut spaced away from the perimeter by a second distance that is greater than the first distance.

6. The carrier of claim 5, wherein each of the first and second relief cuts are arcuate, and wherein each of the first and second relief cuts have a first radius and wherein the third relief cut is arcuate and has a second radius that is larger than the first radius.

7. The carrier of claim 4, wherein each of the first and second relief cuts are arcuate, and wherein each of the first and second relief cuts have a same radius.

8. The carrier of claim 1, wherein the relief cut is a first relief cut, the carrier further comprising a second relief cut arcuate in shape, formed through the main panel and aligned with a first end of the first relief cut.

9. The carrier of claim 8, wherein the carrier further comprises a third relief cut semicircular in shape, formed through the main panel and aligned with a second end of the first relief cut.

10. The carrier of claim 9, wherein the first relief cut includes a first portion separated from a second portion by a gap.

11. The carrier of claim 1, wherein the perimeter of the finger opening is an elongated circle.

12. A blank for forming a carrier for holding a plurality of containers, the blank comprising:
a main panel;
a receptacle defined in the main panel for holding a container;
a finger opening defined within the main panel along a perimeter;
a finger flap defined in the main panel and foldably connected to the main panel at a fold line extending along a portion of the perimeter; and
a relief cut formed in the main panel, the relief cut positioned outside the perimeter and adjacent to the fold line.

13. The blank of claim 12, wherein the perimeter is substantially circular.

14. The blank of claim 12, wherein the relief cut is arcuate.

15. The blank of claim 12, wherein the relief cut is a first relief cut, the blank including a second relief cut formed through the main panel and separated from the first relief cut by a gap.

16. The blank of claim 15, wherein the first and the second relief cuts are spaced away from the perimeter by a first distance and wherein the blank includes a third relief cut formed through the main panel and aligned with the gap, the third relief cut spaced away from the perimeter by a second distance that is greater than the first distance.

17. The blank of claim 16, wherein each of the first and second relief cuts are arcuate, and wherein each of the first and second relief cuts have a first radius and wherein the third relief cut is arcuate and has a second radius that is larger than the first radius.

18. The blank of claim 15, wherein each of the first and second relief cuts are arcuate, and wherein each of the first and second relief cuts have a same radius.

19. The blank of claim 12, wherein the relief cut is a first relief cut, the blank further comprising a second relief cut formed through the main panel and arranged in an arcuate shape that is aligned with a first end of the first relief cut.

20. The blank of claim 12, wherein the relief cut is a first relief cut, the carrier further comprising a second relief cut semicircular in shape, formed through the main panel and aligned with a first end of the first relief cut.

21. The blank of claim 20, wherein the carrier further comprises a third relief cut semicircular in shape, formed through the main panel and aligned with a second end of the first relief cut.

22. The blank of claim 21, wherein the first relief cut includes a first portion separated from a second portion by a gap.

23. The blank of claim 12, wherein the perimeter of the finger opening is an elongated circle.

24. A method for forming, from a blank, a carrier for holding a plurality of containers, the method comprising:
receiving a blank that includes:
a main panel;
a receptacle defined in the main panel for holding a container;
a finger opening defined within the main panel along a perimeter;
a finger flap defined in the main panel and foldably connected to the main panel at a fold line extending along a portion of the perimeter; and
a relief cut formed in the main panel, the relief cut positioned outside the perimeter and adjacent to the fold line; and
forming the carrier from the blank.

25. The method of claim 24, wherein the perimeter is substantially circular.

26. The method of claim 24, wherein the relief cut is arcuate.

27. The method of claim 24, wherein the relief cut is a first relief cut, the carrier including a second relief cut formed through the main panel and separated from the first relief cut by a gap.

28. The method of claim 27, wherein the first and the second relief cuts are spaced away from the perimeter by a first distance and wherein the carrier includes a third relief cut formed through the main panel and aligned with the gap, the third relief cut spaced away from the perimeter by a second distance that is greater than the first distance.

29. The method of claim 28, wherein each of the first and second relief cuts are arcuate, and wherein each of the first and second relief cuts have a first radius and wherein the third relief cut is arcuate and has a second radius that is larger than the first radius.

30. The method of claim 27, wherein each of the first and second relief cuts are arcuate, and wherein each of the first and second relief cuts have a same radius.

31. The method of claim 24, wherein the relief cut is a first relief cut, the carrier further comprising a second relief cut arcuate in shape, formed through the main panel and aligned with a first end of the first relief cut.

32. The method of claim 31, wherein the carrier further comprises a third relief cut semicircular in shape, formed through the main panel and aligned with a second end of the first relief cut.

33. The method of claim 32, wherein the first relief cut includes a first portion separated from a second portion by a gap.

34. The method of claim 24, wherein the perimeter of the finger opening is an elongated circle.
